(19) United States
(12) Patent Application Publication
(10) Pub. No.: US 2013/0323389 A1
(43) Pub. Date: Dec. 5, 2013

(54) COMPETITIVE INHIBITORS OF PRO-OXIDANTS IN EDIBLE LONG CHAIN POLYUNSATURATED TRIGLYCERIDE AND ETHYL ESTER OILS

(71) Applicants: Fredric James Nugent, Saskatoon (CA); Petros Loutas, St. Albert (CA)

(72) Inventors: Fredric James Nugent, Saskatoon (CA); Petros Loutas, St. Albert (CA)

(73) Assignee: Bioriginal Food & Science Corp., Saskatoon (CA)

(21) Appl. No.: 13/485,765

(22) Filed: May 31, 2012

(51) Int. Cl. A23D 9/013

(52) U.S. Cl. 426/546; 426/610; 426/544

(57) ABSTRACT

A composition comprising a competitive inhibitor and an edible long chain polyunsaturated oil or a blend of edible oils, wherein the edible long chain polyunsaturated oil or the blend of edible oils comprises one or more long chain polyunsaturated fatty acids and a pro-oxidant.

### BACKGROUND OF THE INVENTION

1. Field of the Invention

This invention relates to the field of edible oils, and more specifically, to a composition comprising a competitive inhibitor and edible oils or blended edible oil(s) containing long chain polyunsaturated fatty acids and pro-oxidants. In particular, the invention relates to a competitive inhibition of pro-oxidants such as tocopherols, rosemary extract, citric acid and flavonoids in edible triglyceride oils and edible ethyl ester oils.

2. Description of the Related Art

Edible oils containing long chain polyunsaturated fatty acids (LC PUFA) can be used as dietary supplements. The LC PUFAs most commonly used as dietary supplements include arachidonic acid, alpha linolenic acid, docosahexaenoic acid, eicosapentaenoic acid, gamma linolenic acid and linoleic acid. Many of these LC PUFAs are obtained from chemical synthesis or from natural sources of animal, plant, algae, microbial, and genetically modified organisms. LC PUFAs are essential fatty acids critical for the healthy functioning of every cell in the body and are precursors to the synthesis of eicosanoids in humans and animals.

Two types of processes are used to extract edible LC PUFA oils—expression and solvent extraction. The expression of the edible LC PUFA oil is done either with presses or with expellers. Expellers remove approximately 70% of the oil from the seed, leaving behind an oil residue of approximately 4 to 10 percent of oil. The solvent-extraction method has been devised to recover this residual oil. This process involves grinding the residue, extracting with a volatile liquid, and then distilling the oil from the solvent.

Additionally, relining of either expressed or solvent-extracted oil may be done. The general purpose of refining edible oils is to remove minor impurities or substances that cause the edible oil to have poor color or taste or other objectionable properties. Oils intended for edible purposes are, therefore, further processed to remove these substances while retaining their desirable features. The evolution of refining oils has led to a number of new processes. These processes are designed to preserve the LC PUFA while reducing the minor components. The initial capital investments in connection with these new processes were quite expensive; however, as the demand for nutraceuticals grew, the refining of LC PUFA became more economical and evolved into a mainstream process.

There are additional refining processing steps that can change the refined edible LC PUFA oils to fatty acids, ester, and concentrates. The fatty acids are removed from the glycerine (the backbone of the triglyceride) and then fractionated and concentrated into relatively pure fatty acids or esters fractions. The concentrated forms of LC LUFA can then be consumed as an ethyl ester concentrate or converted back to a triglyceride concentrate.

Edible LC PUFA oils contain mixtures of triacylglycerols with different fatty acids and minor components, which are typically mixtures of different minor substances. The minor components include free fatty acids, fatty alcohols, sterols, phosphatides, fat soluble vitamins, and other substances. The LC PUFAs may be extracted from natural sources, synthesized by various organisms, or derived through chemical modification.

There are several disadvantages associated with commercial production of LC PUFA from these sources, however, LC PUFAs derived from animal, plant, algae, microbial, and genetically modified organisms tend to contain a range of fatty acids, and they differ in their positions on the glycerol backbone. Depending on the method of preparation, the type and degree of refining of edible LC PUFA oils, and the purification method used, minor substances may or may not carry over into the finished edible LC PUFA oil. The proportions of minor substances in different edible LC PUFA oils are dependent on the source of the material. Additional minor substances, either from natural and/or synthetic sources, may be added to re-fortify the edible LC PUFA oil.

For example, the amount of tocopherols in specific edible LC PUFA oil depends on the source of the edible LC PUFA oil, the expression process, and the refining procedure used. In freshly expressed edible LC PUFA oil, a range of about 100 ppm (e.g. olive [1]) to 1.500 ppm (e.g. corn [1]) of tocopherol can be found. Refining can remove as much as 15 to 30% of tocopherols; 30% to 70% can be lost with deodorization or steam distillation; and no trace amounts are left after a concentration process.

The susceptibility and rate of oxidation of these different edible oils containing different ranges of LC PUFA can rise dramatically as a function of increasing degree of unsaturation [2] and the absence/presence of minor substances. Oxidative stability of edible LC PUFA oils depends primarily on their fatty acid composition and, to a lesser extent, on the position of fatty acids on the triglycerol molecule. As for the minor substances, such as antioxidants, these should retard the onset of oxidation, extending the shelf-life of edible LC PUFA oils. Depending on the processing conditions, these same minor antioxidant substances can act as an antioxidant or a pro-oxidant, depending on the concentration.

For each edible LC PUFA, there is an optimum ratio between the concentration of the LC PUFA and the minor substances. The optimum antioxidant activity depends to a large degree on the composition of LC PUFA [2] and the nature and concentration of the minor substances extending oxidation. Thus, removing or increasing concentrations of minor substances during manufacture is not always beneficial in terms of improving oxidative stability. For example, increasing minor substances such as metals [3], oxidized lipid compounds [4], carotenoids [5], peroxidases [6], lycopene [5], phenols [3], ascorbic acid [7], chlorophyll pigments [8], green tea extracts [9] and tocopherols [10] is detrimental because these substances are known to act as pro-oxidants.

Intentionally added antioxidants are derived from two sources, natural and synthetic. Examples of natural antioxidants include derivatives of ascorbic acid, tocopherols, tocotreniols, phytosterols, flavonoids, carotenes and other phenols. Examples of synthetic antioxidants are monohydric phenols (e.g. butylhydroxyanisolc and butylhydroxytoluene), diphenol (e.g. tert-butylhydroquinone), gallic acid/phenol esters (propyl gallate) and quinolone (e.g. ethoxyquin).

In some specialty crops, genes have been found that affect fatty acid levels that enable plant breeding and modem biotechnology to tailor the composition of fatty acid. Modification of saturates, oleic acid [11], linolenic acid and gamma linolenic acid [12] in soybean and safflower, for example, can change the fatty acid composition to antioxidant concentration, resulting in an unstable edible LC PUFA oil, particularly before it is processed. Adding more antioxidants, such as antioxidants present in the edible LC PUFA oil, may not be sufficient because it may in fact further decrease the oxidative stability of processed edible LC PUFA oil due to pro-oxidation.

Generally, seeds rich in edible LC PUFA oils are also abundant sources of various types of pro-oxidant substances. Depending on the processing and purification of these edible LC PUFA oils, the optimum ratio between the LC PUFA and the antioxidants (naturally occurring or intentionally added) is changed, resulting in the minor substances exhibiting even more rapid oxidation. Currently, the inhibitory effect of the pro-oxidant activity can be controlled by either reducing the concentration of trace metals and the pro-oxidants or binding the trace metals by chelation. Accordingly, there exists a need for inhibitor(s) that will suppress both natural and synthetic pro-oxidants in edible LC PUFA oil and blends of edible oil(s) containing long chain polyunsaturated fatty acids.

The present invention differs from the prior art in that a specific competitive inhibitor—a second antioxidant with preferentially binding to the fatty acid—is added to prevent pro-oxidation due to excessive amounts of the first antioxidant. This is in lieu of adding an antioxidant to replace the antioxidant removed during the refining process. In the present invention, the inhibitor prevents the further pro-oxidation of the LC PUFA due to excess antioxidant from naturally occurring sources, which were not removed during the expression, solvent extraction or refining process(es). In the prior art, no additional antioxidants would be added in this situation because additional antioxidant cannot reverse any oxidation reactions that have already occurred. Additionally, the present invention proves that the pro-oxidant effects of naturally occurring or intentionally added antioxidants can been inhibited. No such inhibition in the presence of pro-oxidants is taught in the prior art.

### BRIEF SUMMARY OF THE INVENTION

The present invention is a composition comprising a competitive inhibitor and an edible long chain polyunsaturated oil, wherein the edible long chain polyunsaturated oil comprises one or more long chain polyunsaturated fatty acids and a pro-oxidant. In an alternate embodiment, the present invention is a composition comprising a competitive inhibitor and a blend of edible oils, wherein the blend of edible oils comprises one or more long chain polyunsaturated fatty acids and a pro-oxidant.

In a preferred embodiment, the competitive inhibitor is selected from the group consisting of butylhydroxyanisole, butylhydroxytoluene, tert-butylhydroquinone, propyl gallate, and ascorbyl palmitate, and combinations thereof. In one embodiment, the competitive inhibitor is a solid. In an alternate embodiment, the competitive inhibitor is a liquid. In one embodiment, the competitive inhibitor is derived from a natural source. In an alternate embodiment, the competitive inhibitor is derived from a synthetic source.

In a first embodiment, the competitive inhibitor comprises between about 1 ppm and about 2,500 ppm by weight of inhibitor substance. In a second embodiment, the competitive inhibitor comprises between about 10 ppm and about 1,000 ppm by weight of inhibitor substance. In a third embodiment, the competitive inhibitor comprises between about 25 ppm and about 500 ppm by weight of inhibitor substance. In a fourth embodiment, the competitive inhibitor comprises between about 50 ppm and about 200 ppm by weight of inhibitor substance.

In a preferred embodiment, the edible long chain polyunsaturated oil is derived from a source selected from the group consisting of animal, plant, algae, microbial, and genetically modified tissues. In a first embodiment, the edible long chain polyunsaturated oil is derived from a plant source selected from the group consisting of almond oil, borage oil, black currant seed oil, chia seed oil, camelina oil, canola oil, echium oil, evening primrose oil, flaxseed oil, hemp seed oil, sacha inchi oil, high gamma linolenic acid safflower oil, pumpkin seed oil, perilla oil, peanut oil, safflower oil, soybean oil, sunflower oil, walnut oil and wheat germ oil. In a second embodiment, the edible long chain polyunsaturated oil is derived from an animal source selected from the group consisting of anchovies, catfish, cod, flounder, grouper, halibut, herring, mackerel, pollock, swordfish, salmon, sardines, seal oil, snapper, tuna and combinations thereof. In a third embodiment, the edible long chain polyunsaturated oil is derived from an algae source selected from the group consisting of docosahaexanoic acid rich oil, eicosapentaenoic acid rich oil and combinations thereof. In a fourth embodiment, the edible long chain polyunsaturated oil is derived from a microbial source selected from the group consisting of alpha linolenic acid rich oil, docosahexaenoic acid rich oil, eicosapentaenoic acid rich oil, gamma linolenic acid rich oil, linoleic acid rich oil and combinations thereof. In a fifth embodiment, the edible long chain polyunsaturated oil is derived from a genetically modified organism source selected from the group consisting of borage oil, canola oil, corn oil, evening primrose oil, flax oil, safflower oil, soybean oil, sunflower oil and combinations thereof.

In one embodiment, the edible long chain polyunsaturated oil is derived naturally. In an alternate embodiment, the edible long chain polyunsaturated oil is derived through chemical modification. In a preferred embodiment, the edible long chain polyunsaturated oil comprises a long chain polyunsaturated fatty acid selected from the group consisting of Omega-3 long chain polyunsaturated fatty acid. Omega-6 long chain polyunsaturated fatty acid, and combinations thereof. In another preferred embodiment, the edible long chain polyunsaturated oil comprises a long chain polyunsaturated fatty acid selected from the group consisting of arachidonic acid, alpha linolenic acid, docosahexaenoic acid, eicosapentaenoic acid, gamma linolenic acid, linoleic acid and combinations thereof.

In one embodiment, the edible long chain polyunsaturated oil comprises at least 10% by weight long chain polyunsaturated fatty acids. In another embodiment, the edible long chain polyunsaturated oil comprises at least 10% by weight blends of long chain polyunsaturated fatty acids. In one embodiment, the edible long chain polyunsaturated oil comprises at least 30% by weight long chain polyunsaturated fatty acids. In another embodiment, the edible long chain polyunsaturated oil comprises at least 30% by weight blends of long chain polyunsaturated fatty acids. In one embodiment, the edible long chain polyunsaturated oil comprises at least 50% by long chain polyunsaturated fatty acids. In another embodiment, the edible long chain polyunsaturated oil comprises at least 50% by weight blends of long chain polyunsaturated fatty acids. In one embodiment, the edible long chain polyunsaturated oil comprises at least 70% by weight long chain polyunsaturated fatty acids. In another embodiment, the edible long chain polyunsaturated oil comprises at least 50% by weight blends of long chain polyunsaturated fatty acids. In one embodiment, the edible long chain polyunsaturated oil comprises at least 90% by weight long chain polyunsaturated fatty acids. In another embodiment, the edible long chain polyunsaturated oil comprises at least 90% by weight blends of long chain polyunsaturated fatty acids.

In a preferred embodiment, the blend of edible oils is selected from the group consisting of animal, plant, algae, microbial, and genetically modified tissues, and combinations thereof. In a first embodiment, the blend of edible oils is derived from a plant source selected from the group consisting of almond oil, borage oil, black currant seed oil, chia seed oil, camelina oil, canola oil, echium oil, evening primrose oil, flaxseed oil, hemp seed oil, sacha inchi oil, high gamma linolenic acid safflower oil, pumpkin seed oil, perilla oil, peanut oil, safflower oil, soybean oil, sunflower oil, walnut oil, and combinations thereof. In a second embodiment, the blend of edible oils is derived from an animal source selected from the group consisting of anchovies, catfish, cod, flounder, grouper, halibut, herring, mackerel, pollock, swordfish, salmon, sardines, seal oil, snapper, tuna and combinations thereof. In a third embodiment, the blend of edible oils is derived from an algae source selected from the group consisting of docosahaexanoic acid rich oil, eicosapentaenoic acid rich oil and combinations thereof. In a fourth embodiment, the blend of edible oils is derived from a microbial source selected from the group consisting of alpha linolenic acid rich oil, docosahexaenoic acid rich oil, eicosapentaenoic acid rich oil, gamma linolenic acid rich oil, linoleic acid rich oil and combinations thereof. In a fifth embodiment, the blend of edible oils is derived from a genetically modified organism source selected from the group consisting of borage oil, canola oil, corn oil, evening primrose oil, flax oil, safflower oil, soybean oil, sunflower oil and combinations thereof.

In one embodiment, the blend of edible oils is derived naturally. In an alternate embodiment, the blend of edible oils is derived through chemical modification. In a preferred embodiment, the blend of edible oils comprises a long chain polyunsaturated fatty acid selected from the group consisting of Omega-3 long chain polyunsaturated fatty acid. Omega-6 long chain polyunsaturated fatty acid, and combinations thereof. In another preferred embodiment, the blend of edible oils comprises a long chain polyunsaturated fatty acid selected from the group consisting of arachidonic acid, alpha linolenic acid, docosahexaenoic acid, eicosapentaenoic acid, gamma linolenic acid, linoleic acid and combinations thereof.

In one embodiment, the blend of edible oils comprises at least 10% by weight long chain polyunsaturated fatty acids. In another embodiment, the blend of edible oils comprises at least 10% by weight blends of long chain polyunsaturated fatty acids. In one embodiment, the blend of edible oils comprises at least 30% by weight long chain polyunsaturated fatty acids. In another embodiment, the blend of edible oils comprises at least 30% by weight blends of long chain polyunsaturated fatty acids. In one embodiment, the blend of edible oils comprises at least 50% by long chain polyunsaturated fatty acids. In another embodiment, the blend of edible oils comprises at least 50% by weight blends of long chain polyunsaturated fatty acids. In one embodiment, the blend of edible oils comprises at least 70% by weight long chain polyunsaturated fatty acids. In another embodiment, the blend of edible oils comprises at least 70% by weight blends of long chain polyunsaturated fatty acids. In one embodiment, the blend of edible oils comprises at least 90% by weight long chain polyunsaturated fatty acids. In another embodiment, the blend of edible oils comprises at least 90% by weight blends of long chain polyunsaturated fatty acids.

In a preferred embodiment, the pro-oxidant comprises an antioxidant selected from the group consisting of ascorbic acid, ascorbic acid salts, carotenoids, citric acid, flavonoids, lutein, rosemary extract, sage, sterols, tocopherols, tocotrienols and combinations thereof. In one embodiment, the pro-oxidant is naturally-occurring. In an alternate embodiment, the pro-oxidant is added to the edible long chain polyunsaturated fatty acid oil. In one embodiment, the pro-oxidant is derived from a natural source. In an alternate embodiment, the pro-oxidant is derived from a synthetic source.

In a first embodiment, the pro-oxidant comprises between about 200 ppm and about 5,000 ppm by weight of pro-oxidant substance. In a second embodiment, the pro-oxidant comprises between about 700 ppm and about 3,000 ppm by weight of pro-oxidant substance. In a third embodiment, the pro-oxidant comprises between about 1,000 ppm and about 2.000 ppm by weight of pro-oxidant substance.

### BRIEF DESCRIPTION OF THE DRAWINGS

FIG. 1 is a comparison of the OSI induction period (N=4) for high-GLA safflower LC PUFA oil (SONOVA™) with 0 ppm to 3.375 ppm of mixed tocopherols and 0 ppm to 200 ppm of TBHQ measured with AOCS method Cd 12b-92 at 110° C.

FIG. 2 is a comparison of the OSI induction period (N=4) for three different type oils with and without 675 ppm MT, with and without 200 ppm of TBHQ+100 ppm of CA, measured with AOCS method Cd 12b-92 at 110° C.

FIG. 3 is a comparison of the OSI induction period (N=4) for various edible LC PUFA oils with and without 675 ppm MT, with and without 200 ppm TBHQ+100 ppm CA, measured with AOCS method Cd 12b-92 at 110° C.

FIG. 4 is a comparison of the OSI induction period (N=4) for various high-GLA safflower LC PUFA oil and medium GLA borage LC PUFA oil blends with and without 675 ppm MT, with and without 200 ppm TBHQ+100 ppm CA, measured with AOCS method Cd 12b-92 at 110° C.

FIG. 5 is a comparison of the OSI induction period (N=4) for single and blended edible LC PUFA oils with and without 675 ppm MT, with and without 200 ppm TBHQ+100 ppm CA, measured with AOCS method Cd 12b-92 at 110° C.

FIG. 6 is a comparison of the OSI induction period (N=4) for high-GLA safflower LC PUFA oil with and without 1.000 ppm RM, with and without 200 ppm TBHQ+100 ppm CA, measured with AOCS method Cd 12b-92 at 110° C.

FIG. 7 is a comparison of the OSI induction period (N=4) for medium GLA borage LC PUFA oil with and without 1.000 ppm RM, with and without 200 ppm TBHQ+100 ppm CA, measured with AOCS method Cd 12b-92 at 110° C.

FIG. 8 is a comparison of the OSI induction period (N=4) for high-GLA safflower triglyceride oil with 200 ppm TBHQ and 0 to 100 ppm of CA, measured with AOCS method Cd 12b-92 at 110° C.

FIG. 9 is a comparison of the OSI induction period (N=4) for high-GLA safflower triglyceride oil with 675 ppm of MT, 200 ppm of TBHQ and 0 to 100 ppm of CA, measured with AOCS method Cd 12b-92 at 110° C.

### DETAILED DESCRIPTION OF INVENTION

The present invention discloses competitive inhibitors that improve the oxidative stability and the quality of the edible long chain polyunsaturated triglyceride and ethyl ester oils and blends by preventing pro-oxidant effects caused by excessive amounts of antioxidants. In one aspect, the present invention is directed to adding a competitive inhibitor to overcome an imbalance between the long chain polyunsaturated fatty acid and minor components including naturally occurring or intentionally added pro-oxidants. The present invention encompasses edible long chain polyunsaturated oils sourced from chemical, animal, plant, algae, microbial, and genetically modified organisms.

### 1. DEFINITIONS

The phrase “edible LC PUFA oils” as used herein means edible oil or components thereof in forms of glycerol and fatty acids and esters of ethanol and fatty acids that may be employed in nutraceutical or other compositions for an oral administration. As used herein, “LC PUFA” or components thereof refers generally to a form of Omega-3 fatty acid including, but not limited to alpha linolenic acid, docosahexaenoic acid, eicosapentaenoic acid, derivatives thereof and combinations thereof; and Omega 6 fatty acid including, but not limited to arachidonic acid, gamma linolenic acid, linoleic acid, derivatives thereof and combinations thereof. Other members of either the Omega 3 or the Omega 6 fatty acid family are well known in the art. These members, and their derivatives, are encompassed by the terms “Omega 3” and “Omega 6.” as used herein. Edible LC PUFA oils include, but are not limited to those from either natural or synthetic sources. Particularly preferred are edible LC PUFA oils suitable from a plant source of almond oil, borage oil, black currant seed oil, chia seed oil, camelina oil, canola oil, echium oil, evening primrose oil, flaxseed oil, hemp seed oil, sacha inchi oil, high-GLA safflower oil, pumpkin seed oil, perilla oil, peanut oil, safflower oil, soybean oil, sunflower oil, walnut oil and wheat germ oil; from an animal source of anchovies, catfish, cod, flounder, grouper, halibut, herring, mackerel, pollock, swordfish, salmon, sardines, seal oil, snapper, tuna and combinations thereof; from an algae source of docosahaexanoic acid rich oil, eicosapentaenoic acid rich oil and combinations thereof; from a microbial source of alpha linolenic acid rich oil, docosahexaenoic acid rich oil, eicosapentaenoic acid rich oil, gamma linolenic acid rich oil, linoleic acid rich oil and combinations thereof; from a genetically modified organism source of borage oil, canola oil, corn oil, evening primrose oil, flax oil, safflower oil, soybean oil, sunflower oil and combinations thereof. Other edible LC PUFA oils are known by those skilled in the art. A wide variety of edible LC PUFA oils is commercially available from sources known to those skilled in the art.

The term “competitive inhibitor” as used herein means a substance that restrains, blocks, suppresses or retards the oxidation and usually resembles the pro-oxidant in chemical structure. Competitive inhibitors suitable for use in the present invention are well known in the art as antioxidants and include, but are not limited to natural or synthetic inhibitors and combinations thereof. These edible LC PUFA oil soluble inhibitors are generally liquids hut can also be used as crystals, powdered solids and the like. Suitable competitive inhibitors include, but are not limited to butylhydroxyanisole, butylhydroxytoluene, tert-butylhydroquinone, propyl gallate, and ascorbyl palmitate and combinations thereof.

The term “pro-oxidant” as used herein means an anti-oxidant substance used at sufficiently higher concentration (higher than typical for anti-oxidant activity) that induces oxidative stress. Pro-oxidants used in the present invention include, but are not limited to ascorbic acid, ascorbic acid esters/salts, carotenoids, flavonoids, lutein, rosemary extract, sage, sterols, tocopherols and tocotrienols and combinations thereof. In a preferred embodiment, tocopherol is utilized as a natural antioxidant.

### 2. COMPETITIVE INHIBITORS

Novel competitive inhibitors of pro-oxidants in edible oils containing highly concentrated LC PUFAs have been discovered. The present invention involves the incorporation of a second specific substance, a competitive inhibitor substance, into the edible oil containing highly concentrated LC PUFA so as to, in part, prevent the oxidative stability and inhibit the edible LC PUFA oil from rapid oxidation due to naturally occurring or intentionally added pro-oxidants.

The dietary supplement industry is often confronted with poor oxidative stability relating to edible and edible blended oil(s) containing LC PUFA. Indeed, poor quality edible oil may deteriorate (for example, the odor and taste parameter), consequently failing to meet the consumer appeal and acceptance. Accordingly, the present invention provides competitive inhibitors that will serve to increase consumer satisfaction by, for example, incorporating a substance into various edible LC PUFA oils and edible LC PUFA oil blends, resulting in an improved quality profile of the edible LC PUFA oil or edible LC PUFA oil blends.

In addition, these competitive inhibitors of the invention do not change the odor, flavor or color to the edible LC PUFA oil and are effective at low concentrations, readily blended into edible LC PUFA oils, economical and safe to use. Particular to safety, the present invention allows low concentrations of competitive inhibitors. This is important because dietary supplements must remain in compliance with U.S. Food and Drug Administration [13]. For example, the inhibitor tert-butylhydroquinone is restricted to a concentration of 200 ppm by weight of the edible LC PUFA oil. Alternatively, or in addition, the inhibitors of the present invention improve the oxidative stability of other quality parameters, such as peroxide value, para-anisidine value, total oxidation value and color. Such features further serve to enhance the appeal of the edible LC PUFA oil, thereby enhancing consumer compliance and acceptance.

The present invention provides a competitive inhibitor to pro-oxidation in an edible LC PUFA or blended edible LC PUFA oil(s). The competitive inhibitor preferentially binds to the active double-bond site and inhibits or prevents an oxidation reaction of the LC PUFA in the edible oil. In a preferred embodiment, the competitive inhibitor is soluble in edible LC PUFA oil. In general, when a competitive inhibitor of the invention is mixed with edible LC PUFA oil, one phase is formed, with substantially all of the competitive inhibitor being in the edible LC PUFA oil phase.

The competitive inhibitor should be present in an amount sufficient to provide a distinct oxidative stability on the part of the edible LC PUFA oil. In a preferred embodiment, the competitive inhibitor is present in an amount sufficient to prevent an otherwise undesirable or loss of quality of the edible LC PUFA oil composition, for example, that of the degrading of LC PUFAs found in the edible oil.

In alternate embodiments, the competitive inhibitor includes at least about 1 ppm, 5 ppm, 10 ppm, 25 ppm, 50 ppm, 75 ppm, 100 ppm, 200 ppm, 300 ppm, 400 ppm, 500 ppm, 600 ppm, 700 ppm, 800 ppm, 900 ppm, 1,000 ppm, 1,250 ppm, 1,500 ppm, 1,750 ppm, 2,000 ppm, 2,250 ppm, and 2,500 ppm by weight of edible triglyceride oil. In preferred embodiments, the competitive inhibitor includes between about 1 ppm and about 2,500 ppm by weight, between about 10 ppm and about 1,000 ppm by weight, or between about 50 ppm and about 200 ppm by weight of edible LC PUFA oil-soluble inhibitor. Ranges intermediate to the above recited amounts, e.g. about 35 ppm to about 1,250 ppm by weight of edible LC PUFA oil soluble inhibitor, are also intended to be included in this invention. For example, ranges of values using a combination of any of the above recited values as upper and/or lower limits are intended to be included.

The edible LC PUFA oil of the present invention includes at least one pro-oxidant. In a particular embodiment, the edible LC PUFA oil includes each of, but is not limited to natural occurring pro-oxidants and intentionally added pro-oxidants.

In alternate embodiments, the pro-oxidant includes at least about 200 ppm, 300 ppm, 400 ppm, 500 ppm, 600 ppm, 700 ppm, 800 ppm, 900 ppm, 1,000 ppm, 1,500 ppm, 2,000 ppm, 3,000 ppm, 3,500 ppm, 4,000 ppm, 4,500 ppm and 5,000 by weight of edible LC PUFA oil. In preferred embodiments, the pro-oxidant includes between about 200 ppm and about 1,500 ppm by weight, between about 300 ppm and about 1,200 ppm by weight, or between about 330 ppm and about 500 ppm by weight of pro-oxidant. Ranges intermediate to the above recited amounts, e.g. about 750 ppm to about 1,250 ppm by weight of pro-oxidant, are also intended to be included in this invention. For example, ranges of values using a combination of any of the above recited values as upper and/or lower limits are intended to be included.

The edible LC PUFA oil(s) are present in the composition of the present invention at levels determined by various factors including, but not limited to caloric content, the number of and nature of the components of the composition (such as the fatty acids), and health benefits of Omega 3 and Omega 6 fatty acids. The edible LC PUFA oil should be generally present in the serving amounts of at least 0.25 g, 0.5 g, 1.0 g, 2.0 g, 3.0 g, 4.0 g, 5.0 g, 6.0 g, 7.0 g, 8.0 g, 9.0 g, 10.0 g, 15.0 g, 20.0 g, 30.0 g, 40.0 g, 50.0 g, or 60.0 g. Ranges intermediate to the above recited amounts, e.g., about 2.8 g to about 21.8 g of edible LC PUFA oil, are also intended to be included in this invention. For example, ranges of values using a combination of any of the above recited values as upper and/or lower limits are intended to be included.

An official method for determining the resistance to oxidation is the oxidative stability index (OSI, AOCS Cd 12b-92[14]). As a measure of resistance of the edible LC PUFA oil to oxidation, the induction period (typically in hours) for the OSI is the length of time before the rapid acceleration of oxidation starts. Although there are many factors that affect edible LC PUFA oil, the OSI induction period is useful, along with other measures, for making predictions about edible LC PUFA oil oxidation stability (especially pro-oxidants). For example, a synergistic effect of antioxidants [15] can be described mathematically as:

IP₁₂−(IP₁+IP₂)>0

where:
IP₁₂ is the induction period of the antioxidants 1 and 2.
IP₁ is the induction period of antioxidant 1, and
IP₂ is the induction period of antioxidant 2.
   Several synergistic blends are available commercially, especially citric acid with tert-butylhydroquinone, butylhydroxyanisole with butylhydroxytoluene, and tert-butylhydroquinone with propyl gallate. Alternatively, these blends may be incorporated into edible LC PUFA oils of the present invention as inhibitors of pro-oxidants.

Conversely, a pro-oxidant effect can be represented as:

IP₁₂−(IP₁−IP₂)<0

Minor antioxidant substances have been shown to have pro-oxidant effects at concentrations as low as 5 ppm (lutein), 100 ppm (alpha-tocopherol), 250 ppm (gamma tocopherol), and 500 ppm (delta tocopherol).

Finally, an additive effect can be represented as:

IP₁₂−(IP₁+IP₂)≈0

In this case, the combination of two antioxidants produces a total antioxidant effect equal to the sum of the individual antioxidants.

### 3. EXAMPLES

### A. Abbreviations

For the purpose of the examples, the following abbreviations are used:

ALA—alpha linolenic acid

AOCS—American Oil Chemists' Society

CA—citric acid

DHA—docosahexacnoic acid

EPA—eicosapentaenoic acid

EPO—evening primrose oil

GLA—gamma linolenic acid

LC MUFA—long chain monounsaturated fatty acids

LC PUFA—long chain polyunsaturated fatty acids

MT—mixed tocopherols

ppm—parts per million

RM—rosemary extract

SBFF—SONOVA™+borage+flax+fish

TBHQ—tert-butylhydroquinone

### B. Example 1

### Exemplary of Pro-Oxidants in an Edible LC PUFA Oil

This example illustrates the MT pro-oxidant activity in commercially available edible LC PUFA oil. High-GLA safflower LC PUFA oil (SONOVA™ from Arcadia Biosciences, Inc. of Davis, Calif. U.S.A.) containing about 40% by weight GLA (with oleic safflower triglyceride oil, mixed tocopherols, citric acid, ascorbyl palmitate and rosemary extract) was blended with 335 ppm to 3,375 ppm of a MT pro-oxidant (67.5% mixed tocopherols from Archer Daniels Midland Company of Decatur, Ill. U.S.A.) and 0 ppm to 200 ppm of a TBHQ competitive inhibitor (TENOX 20™ [20% TBHQ+10% CA] from Eastman Chemical Company of Kingspon, Tenn. U.S.A.).

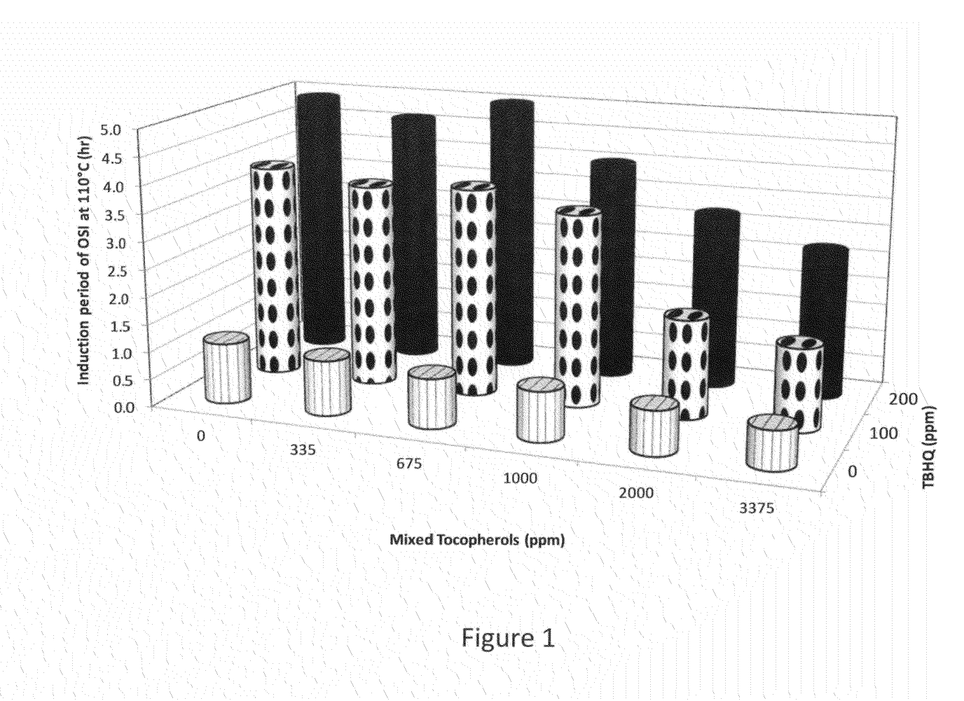

Referring to FIG. 1 (following the mixed tocopherol primary vertical axis only), further increasing the concentration of MT (as the oil already contains MT) in the high-GLA safflower LC PUFA oil exhibited a MT pro-oxidant effect. Increasing MT pro-oxidant concentration increased the rate of oxidation, thereby decreasing the induction period. More MT pro-oxidant molecules collide with fatty acids, resulting in more oxidized fatty acids. After a certain MT pro-oxidant concentration (not yet reached), further MT increases will have no further effect on the rate of oxidation because the fatty acids will effectively become saturated and will be oxidizing at their maximum possible rate.

The addition of TBHQ to the blend of high-GLA safflower LC PUFA oil and MT pro-oxidant showed competitive inhibition at all concentrations of the MT pro-oxidant (following the TBHQ depth axis) by increasing all the induction periods. At any given TBHQ competitive inhibitor concentration, the rate of oxidation decreased, as shown by the increased the induction period. In competitive inhibition, a fatty acid can bind MT pro-oxidant or TBHQ competitive inhibitor but not both. Under these conditions, the TBHQ competitive inhibitor out-competes the MT pro-oxidant for the active site. The TBHQ competitive inhibitor resembles the MT pro-oxidant but has preferential binding to the active site of the fatty acid.

### C. Example 2

### Exemplary Inhibition of Pro-Oxidants in Different Types of Edible LC PUFA Oils

This example examines the effect of MT pro-oxidants on the induction period of different types of edible oils containing LC PUFAs and with and without added TBHQ competitive inhibitor.

The following three oils (manufactured by Bioriginal Food and Science Corp. of Saskatoon, Saskatchewan, Canada):

fish 18/12 (with mixed tocopherols).

krill (with no added antioxidant), and

fish 3322EE (with mixed tocopherols)

were blended with and without 675 ppm of MT pro-oxidant and 200 ppm of TBHQ competitive inhibitor (TENOX 20™). The various blends were evaluated by OSI at 110° C. for an induction period.

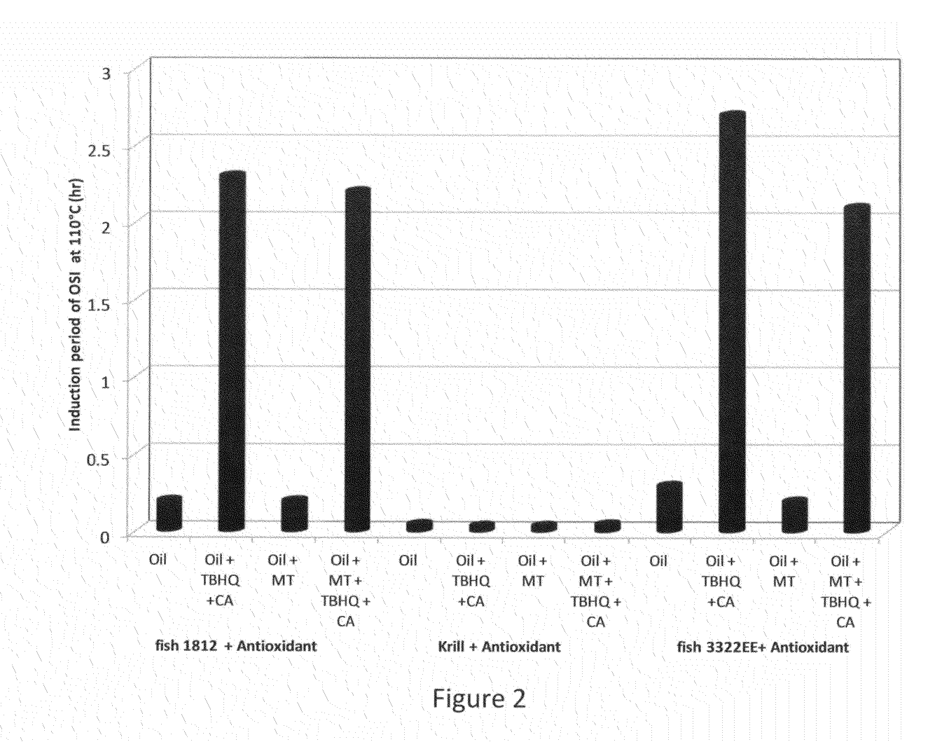

In FIG. 2, the pro-oxidant effect is illustrated by the fact that a decrease in the induction period is found when comparing “Oil” to “Oil+MT [pro-oxidant] or “Oil+TBHQ+CA” to “Oil+MT [pro-oxidant]+TBHQ+CA [competitive inhibitor].” The fish 1812 triglyceride and the fish 3322EE oil showed MT pro-oxidation, whereas krill oil did not show MT pro-oxidation. Additionally, the TBHQ competitive inhibitor suppressed the MT pro-oxidant when these substances were blended together in either edible triglyceride oil or edible ethyl ester oil. Because the krill is phosphatide (LC PUFA conjugated with phospholipids), no MT pro-oxidant effect or TBHQ competitive inhibition was observed.

### D. Example 3

### Exemplary Inhibition of Pro-Oxidants in a Single LC PUFA Edible Oil

This example investigates the effect on the induction period when adding a TBHQ competitive inhibitor to various edible triglyceride oils containing varying LC PUFA compositions and with and without added MT pro-oxidants.

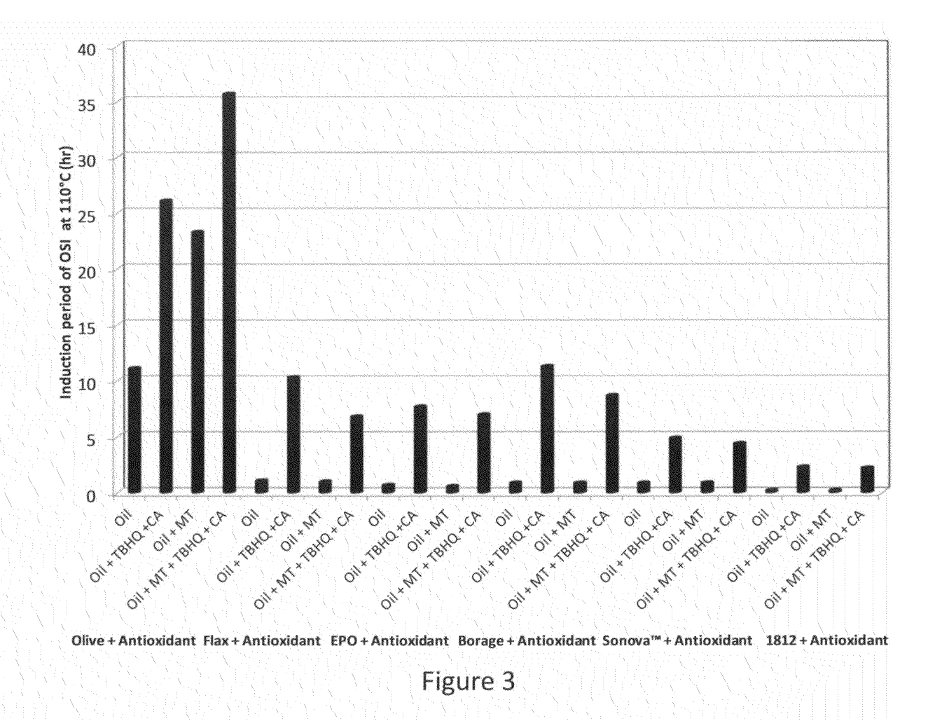

Six commonly used edible LC PUFA oils (manufactured by Bioriginal Food and Science Corp. of Saskatoon, Saskatchewan, Canada):
olive (with no added antioxidants).
flax (with rosemary extract, mixed tocopherols, ascorbyl palmitate and citric acid),
EPO (with added antioxidants),
borage (with no added antioxidants),
SONOVA™ (with oleic safflower triglyceride oil, mixed tocopherols, citric acid, ascorbyl palmitate and rosemary extract), and
fish 1812 (with mixed tocopherols),
   each containing differing LC PUFA distributions, were blended with and without 675 ppm of MT pro-oxidant and with and without the addition of 200 ppm of a TBHQ competitive inhibitor (TENOX 20™). The results are shown in FIG. 3.

Based on the induction periods, the MT pro-oxidant effects were observed for all edible LC PUFA oils, except olive oil. Because olive oil contains large quantities of LC MUFAs and only small quantities of LC PUFA (Table 1), no MT pro-oxidant effect was observed. The combination of MT pro-oxidant with a TBHQ competitive inhibitor to all the edible LC PUFA oils, except olive oil, suppressed the MT pro-oxidant as evidenced by a decrease in the induction period as compared to TBHQ competitive inhibitor. For olive oil, the combination of MT antioxidant and TBHQ competitive inhibitor increased the induction period due to the synergistic effect of the two antioxidants. This synergism of the two antioxidants appears to be due to non-specific oxidation site interaction on LC MUFAs with the antioxidant.

TABLE 1
A comparison of the fatty acids and saturation
compositions of various edible LC PUFA oils

| Fatty Acid | Olive | Flax | EPO | Borage | Sonova | 1812 |
|---|---|---|---|---|---|---|
| C18:1n9 Oleic | 659.1 | 146.4 | 62.4 | 161.8 | 260.0 | 78.9 |
| C18:2 Linoleic | 94.7 | 152.4 | 649.9 | 333.0 | 132.1 | 11.2 |
| C18:3n6 gamma- | 0.0 | 0.0 | 81.6 | 189.9 | 393.8 | 5.8 |
| Linolenic | | | | | | |
| C18:3n3 alpha-Linolenic | 6.4 | 508.4 | 1.7 | 1.7 | 1.1 | 8.0 |
| C20:5n3 | 0.0 | 0.0 | 0.0 | 0.0 | 0.0 | 160.2 |
| Eicosapentaenoic | | | | | | |
| C22:6n3 | 0.0 | 0.0 | 0.0 | 0.0 | 0.0 | 105.5 |
| Docosahexaenoic | | | | | | |
| Total Saturates | 147.3 | 84.6 | 78.8 | 150.5 | 91.6 | 245.2 |
| Total LC MUFAs | 675.6 | 152.8 | 70.8 | 248.7 | 270.2 | 229.8 |
| Total LC PUFAs | 101.1 | 661.4 | 746.7 | 527.6 | 527.3 | 362.6 |

### E. Example 4

### Exemplary Inhibition of Pro-Oxidants in a Binary Blend of Edible LC PUFA Oil

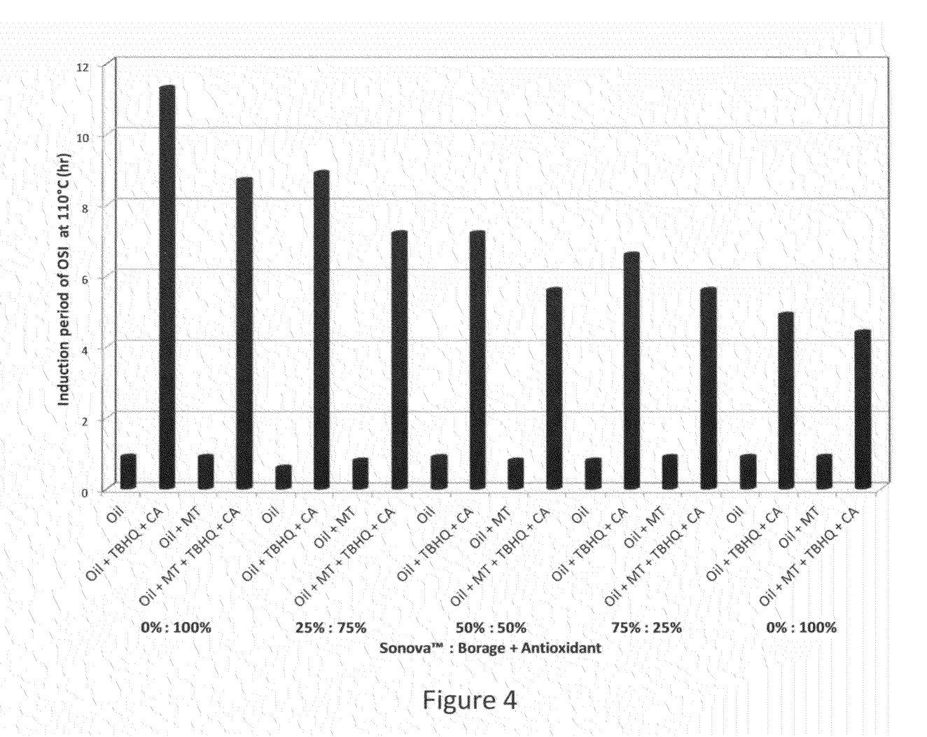

In this example, a TBHQ competitive inhibitor was added to a binary blend of high-GLA safflower and medium-GLA borage edible LC PUFA oils commercially used in dietary supplement products. Samples of the following blended edible LC PUFA oils:
0% SONOVA™ (with oleic safflower triglyceride oil, mixed tocopherols, citric acid, ascorbyl palmitate and rosemary extract)+100% borage (with no added antioxidants),
25% SONOVA™+75% borage.
50% SONOVA™+50% borage,
75% SONOVA™+25% borage, and
100% SONOVA™+0% borage
   were prepared by adding combinations of 675 ppm of MT pro-oxidant and 200 ppm of TBHQ competitive inhibitor (TENOX 20™), as shown in FIG. 4.

The results (FIG. 4) show the MT pro-oxidant effect and the effectiveness of the TBHQ competitive inhibitor in suppressing the MT pro-oxidant in a binary blend of edible LC PUFA oils.

### F. Example 5

### Exemplary Inhibition of Pro-Oxidants in a Multi-Blend of Edible LC PUFA Oils

Generally, edible LC PUFA oil blends target-specific fatty acid compositions. In this example, desired fatty acid distributions were prepared from blending high-GLA safflower, medium-GLA borage, high-ALA flax and low-EPA and low-DHA fish oils, as described below (Table 2).

TABLE 2
A typical multi-blend composition of various edible LC PUFA oils
Edible LC PUFA Oil Blend (SBFF)

| Description | (%) |
|---|---|
| SONOVA 400 ™ (with oleic safflower triglyceride oil, | 16.7 |
| mixed tocopherols, citric acid, ascorbyl palmitate | |
| and rosemary extract) | |
| Borage (with no added antioxidants) | 16.7 |
| Flax (with rosemary extract, mixed tocopherols. ascorbyl | 33.3 |
| palmitate and citric acid) | |
| Fish 1812 (with mixed tocopherols) | 33.3 |
| MT | 675 ppm |
| TBHQ | 200 ppm |
| + CA (TENOX 20 ™) | 100 ppm |

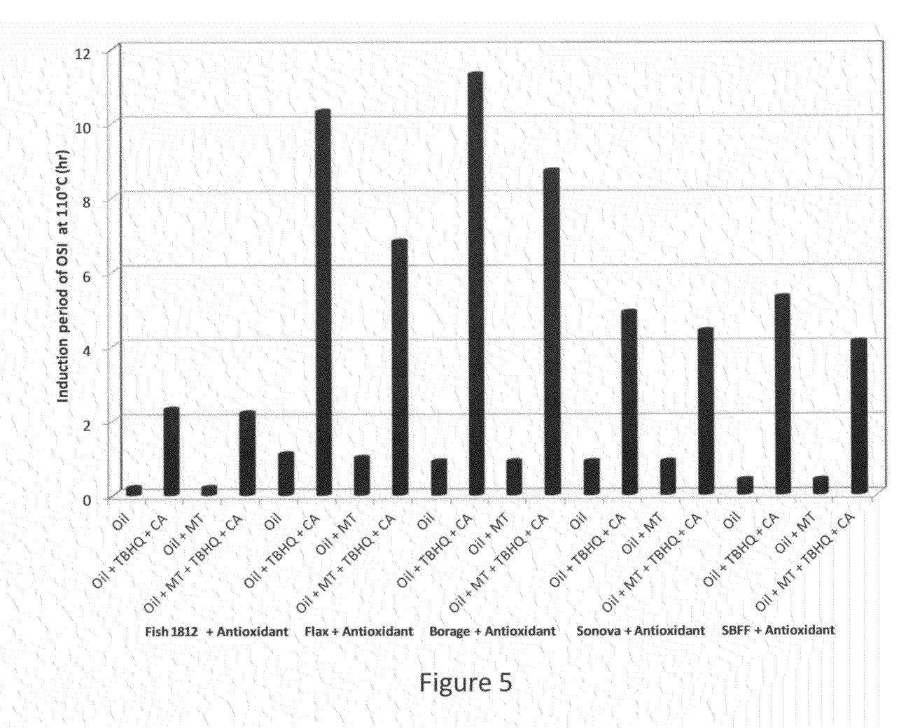

FIG. 5 shows the induction period of each component in the multi-blend edible LC PUFA oil and the multi-blend of the edible LC PUFA oil, with and without TBHQ competitive inhibitor or MT pro-oxidant.

Adding TBHQ competitive inhibitor to single-oil or multi-blend of edible LC PUFA oils showed the MT pro-oxidant effect and the competitive inhibition of MT pro-oxidant.

### G. Example 6

### Exemplary Inhibition of Different Pro-Oxidants

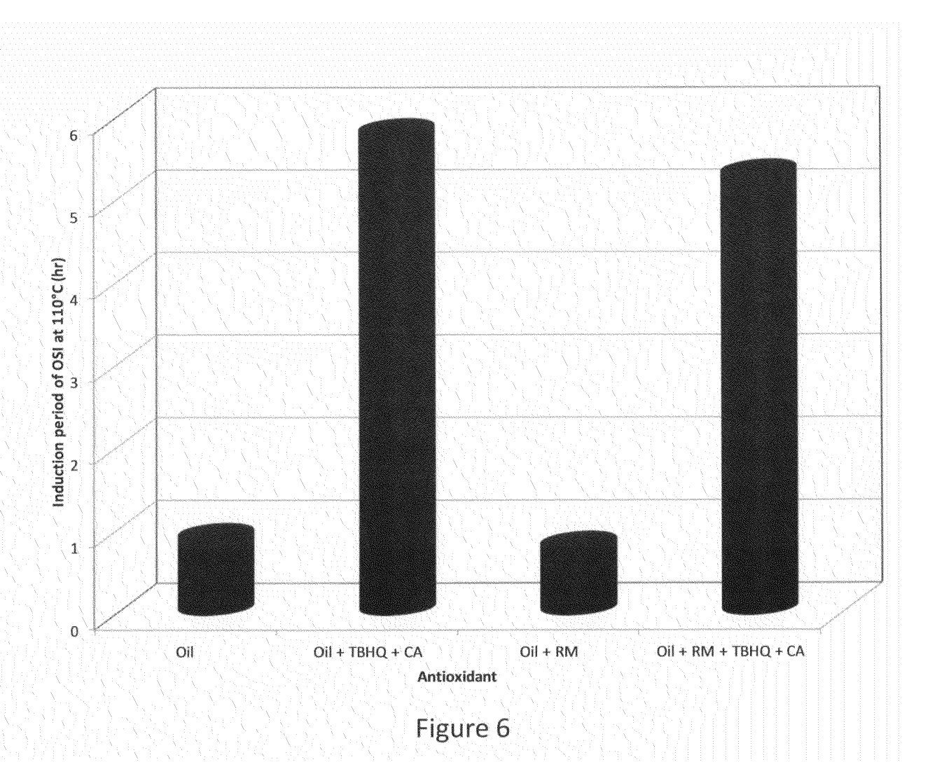

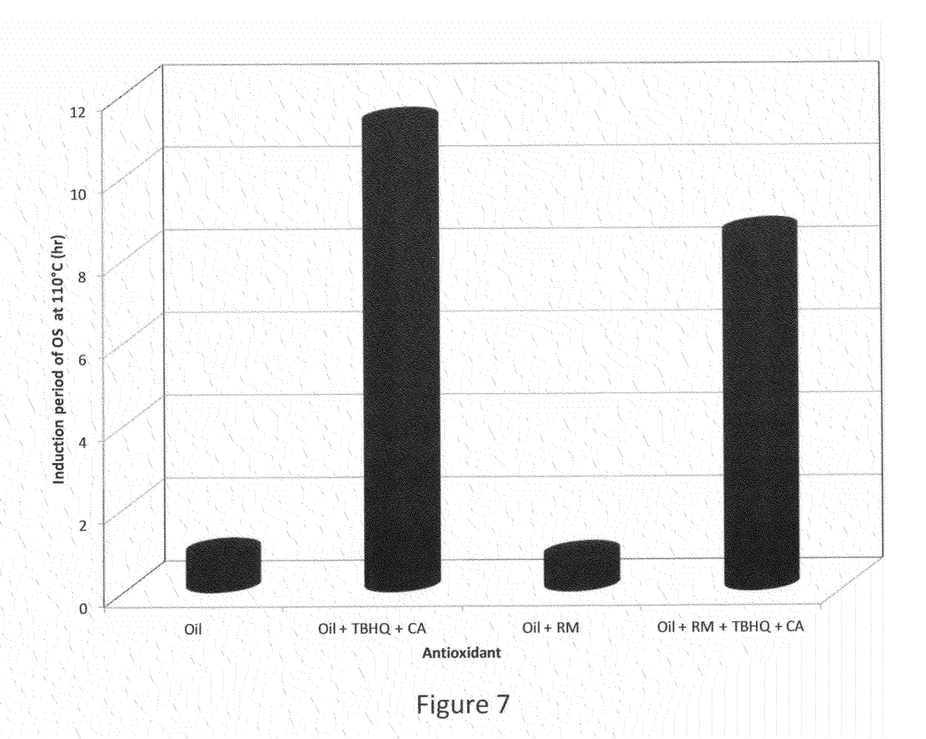

These two examples examine the effect of another pro-oxidant on two different edible LC PUFA oils containing an inhibitor. In the first example, 1,000 ppm of RM pro-oxidant and 200 ppm of TBHQ competitive inhibitor (TENOX 20™) were blended with high-GLA safflower LC PUFA oil. In the second example, 1,000 ppm of RM pro-oxidant and 200 ppm of TBHQ competitive inhibitor (TENOX 20™) were blended with medium-GLA borage LC PUFA oil. The results are shown in FIGS. 6 and 7, respectively.

Using a TBHQ competitive inhibitor in each of the two edible LC PUFA oils confirmed the RM pro-oxidant effect. The TBHQ competitive inhibitor also prevented the RM pro-oxidant from further reducing the stability of the edible LC PUFA oil.

### G. Example 7

### Exemplary Inhibition of Citric Acid Pro-Oxidant

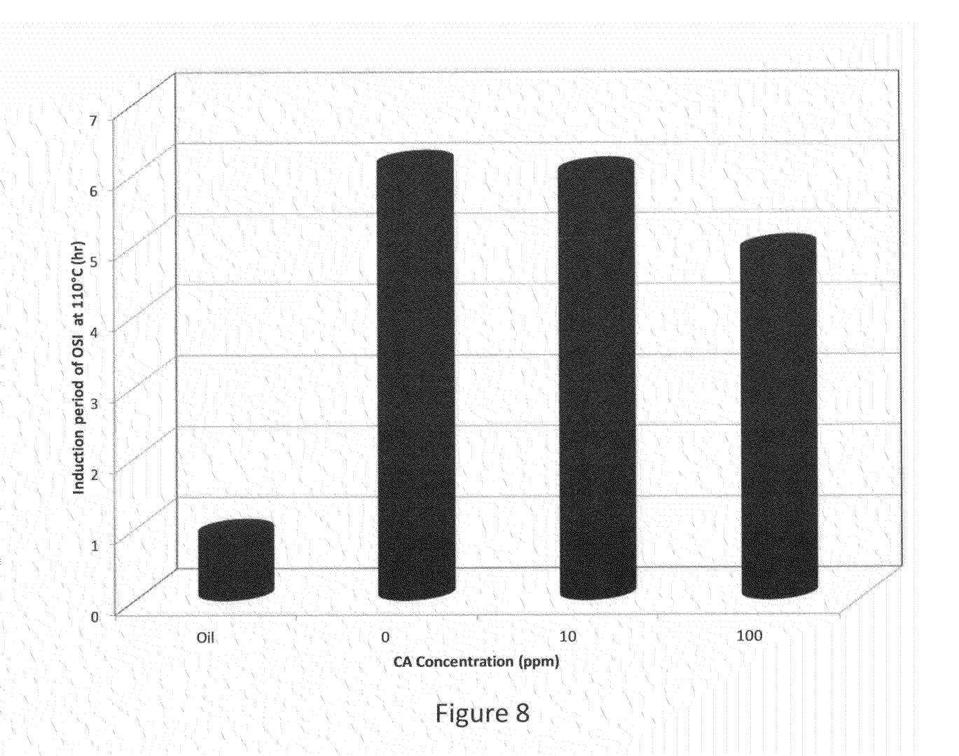

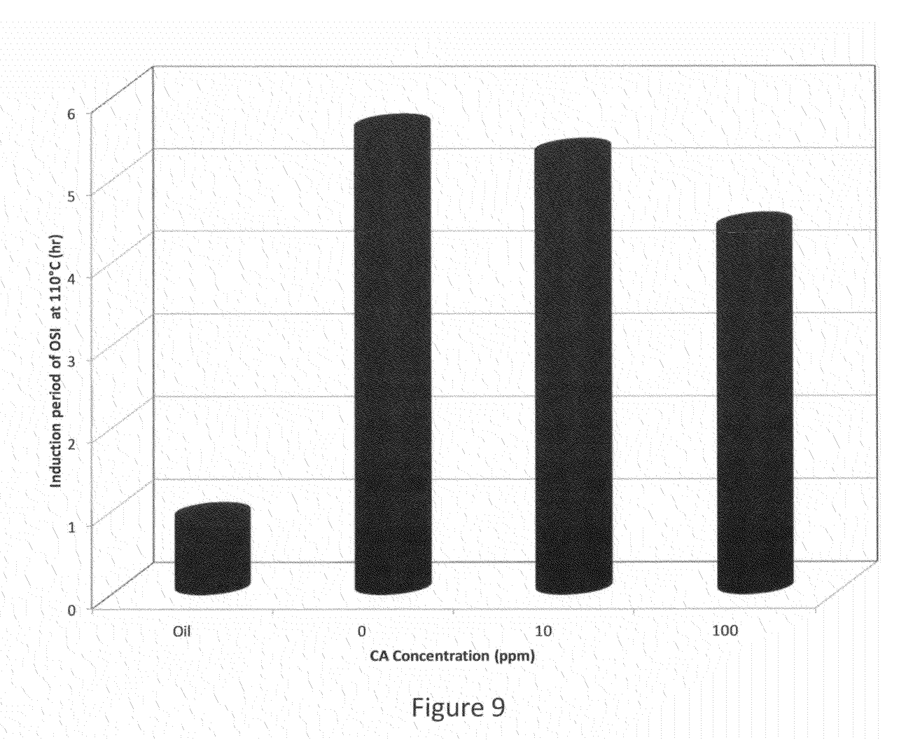

In this example, three commercial combination products of TBHQ and CA were evaluated. High-GLA safflower triglyceride oil was combined with and without combinations of 675 ppm of MT pro-oxidant and with and without:
200 ppm of TBHQ (TENOX™ TBHQ [99% TBHQ] from Eastman Chemical Company of Kingsport, Tenn., U.S.A.).
200 ppm of TBHQ and 10 ppm of CA (BIOEXTEND 30™ [30% TBHQ+1.5% CA] from Eastman Chemical Company of Kingsport, Tenn. U.S.A.), and
200 ppm TBHQ and 100 ppm CA (TENOX 20™ [20% TBHQ+10% CA] from Eastman Chemical Company of Kingsport. Tenn. U.S.A.).
   The effects of citric acid pro-oxidation on the induction period are shown in FIGS. 8 and 9.

Referring to FIGS. 8 and 9, increasing the concentration of CA pro-oxidant in high-GLA safflower LC PUFA oil, with and without MT pro-oxidant, resulted in a CA pro-oxidant effect on the LC PUFA. Although CA typically acts as sequestering agent and synergist, increasing CA also caused pro-oxidation.

Although the preferred embodiments of the present invention have been shown and described, it will be apparent to those skilled in the art that many changes and modifications may be made without departing from the invention in its broader aspects. The appended claims are therefore intended to cover all such changes and modifications as fall within the true spirit and scope of the invention.

### REFERENCES

1. O'Brien, R. D. “Chapter 1—Raw Materials.” Fats and Oils: Formulating and Processing for Applications, CRC Press (2009).
2. Shahidi, F. “Chapter 14—Quality Assurance of Fats and Oils,” Bailey's Industrial Oil and Fat Products, Sixth Ed., Vol. 1. Edible Oil and Fat Products: Chemistry, Properties, and Health Effects, Shahidi, F. (Ed.). Wiley InterScience (2005).
3. Wanasundaral, P. K. J. P. D. and F. Shahidi, “Chapter 11—Antioxidants: Science, Technology, and Applications,” Bailey's Industrial Oil and Fat Products, Sixth Ed. Vol. 1. Edible Oil and Fat Products: Chemistry, Properties, and Health Effects, Shahidi, F. (Ed.). Wiley InterScience (2005).
4. Gomes. T. D. Delcuratolo, V. M. Paradiso, C. Summo and F. Caponio, “Pro-oxidant activity of oxidized triacylglycerols in olive oil and comparison with pro-oxidant action of polar triacylglycerol oligopolymers.” Food Science and Technology 44, 1236-1239 (2011).
5. Haila, K. “Effects of Carotenoids and Carotenoid-Tocopherol Interaction on Lipid Oxidation In Vitro.” University of Helsinki. Department of Applied Chemistry and Microbiology Helsinki Academic Dissertation, 41 (1999).
6. Yanishlieva-Maslarova, N. V. and I. M. Heinonen, “Chapter 10—Sources of Natural Antioxidants: vegetables, fruits, herbs, spices and teas,” Antioxidants in Food: Practical Applications, Pokorny, J. N. Yanishlieva and M. Gordon (Eds.). CRC Press (2001).
7. Ramanathan, L. and N. P. Das, “Effect of natural copper chelating components on the pro-oxidant activity of ascorbic acid in steam-cooked ground fish.” Intern. J. Food Sci. Technol. 28, 279-88 (1993).
8. Usuki, R. Y. Endo and T. Kaneda, “Prooxidant activities of chlorophylls and pheophytins on the photooxidation of edible oils,” Agric. Biol. Chem. 48, 991-994 (1984).
9. Wanasundara, U. N. and F. Shahidi. “Antioxidant and Pro-oxidant Activity of Green Tea Extracts in Marine Oils,” Food Chemistry 63, 335-342 (1998).
10. Shahidi, F. and Y. Zhong, “Chapter 12—Antioxidants: Regulatory Status,” Bailey's Industrial Oil and Fat Products, Sixth Ed. Vol. 1. Edible Oil and Fat Products: Chemistry, Properties, and Health Effects, Shahidi, F. (Ed.). Wiley InterScience (2005).
11. Cahoon, E. B., T. E. Clemente, H. G. Damude and A. J. Kinney, “Chapter 2—Modifying Vegetable Oils for Food and Non-Food Purposes.” Handbook of Plant Breeding, Vollman, J. and I. Rajcan (Eds.). Springer Science (2009).
12. Metz, J. G., J. M. Kuner, J. C. Lippmeier, M. M. Moloney and C. L. Nykiforuk, U.S. Patent Application Pub. No. 2007/0245431 (2007).
13. 21 C.F.R. §172,185. Subpart B. “Food Preservatives—TBHQ.” U.S. Food and Drug Administration (2012).
14. “Official Methods and Recommended Practices of the AOCS,” Fifth Ed. Firestone, D. (Ed.). American Oil Chemist Society (1997).
15. Yanishlieva-Maslarova, N. V. “Chapter 3—Inhibiting Oxidation,” Antioxidants in Food: Practical Applications, Pokorny. J. N. Yanishlieva and M. Gordon (Eds.). CRC Press (2001).

We claim:

1. A composition comprising a competitive inhibitor and an edible long chain polyunsaturated oil, wherein the edible long chain polyunsaturated oil comprises one or more long chain polyunsaturated fatty acids and a pro-oxidant.

2. A composition comprising a competitive inhibitor and a blend of edible oils, wherein the blend of edible oils comprises one or more long chain polyunsaturated fatty acids and a pro-oxidant.

3. The composition of claim 1 or 2, wherein the competitive inhibitor is selected from the group consisting of butylhydroxyanisole, butylhydroxytoluene, tert-butylhydroquinone, propyl gallate, and ascorbyl palmitate, and combinations thereof.

4. The composition of claim 1 or 2, wherein the competitive inhibitor is a solid.

5. The composition of claim 1 or 2, wherein the competitive inhibitor is a liquid.

6. The composition of claim 1 or 2, wherein the competitive inhibitor is derived from a natural source.

7. The composition of claim 1 or 2, wherein the competitive inhibitor is derived from a synthetic source.

8. The composition of claim 1 or 2, wherein the competitive inhibitor comprises between about 1 ppm and about 2,500 ppm by weight of inhibitor substance.

9. The composition of claim 1 or 2, wherein the competitive inhibitor comprises between about 10 ppm and about 1,000 ppm by weight of inhibitor substance.

10. The composition of claim 1 or 2, wherein the competitive inhibitor comprises between about 25 ppm and about 500 ppm by weight of inhibitor substance.

11. The composition of claim 1 or 2, wherein the competitive inhibitor comprises between about 50 ppm and about 200 ppm by weight of inhibitor substance.

12. The composition of claim 1, wherein the edible long chain polyunsaturated oil is derived from a source selected from the group consisting of animal, plant, algae, microbial, and genetically modified tissues.

13. The composition of claim 1, wherein the edible long chain polyunsaturated oil is derived from a plant source selected from the group consisting of almond oil, borage oil, black currant seed oil, chia seed oil, camelina oil, canola oil, echium oil, evening primrose oil, flaxseed oil, hemp seed oil, sacha inchi oil, high gamma linolenic acid safflower oil, pumpkin seed oil, perilla oil, peanut oil, safflower oil, soybean oil, sunflower oil, walnut oil and wheat germ oil.

14. The composition of claim 1, wherein the edible long chain polyunsaturated oil is derived from an animal source selected from the group consisting of anchovies, catfish, cod, flounder, grouper, halibut, herring, mackerel, pollock, swordfish, salmon, sardines, seal oil, snapper, tuna and combinations thereof.

15. The composition of claim 1, wherein the edible long chain polyunsaturated oil is derived from an algae source selected from the group consisting of docosahaexanoic acid rich oil, eicosapentaenoic acid rich oil and combinations thereof.

16. The composition of claim 1, wherein the edible long chain polyunsaturated oil is derived from a microbial source selected from the group consisting of alpha linolenic acid rich oil, docosahexaenoic acid rich oil, eicosapentaenoic acid rich oil, gamma linolenic acid rich oil, linoleic acid rich oil and combinations thereof.

17. The composition of claim 1, wherein the edible long chain polyunsaturated oil is derived from a genetically modified organism source selected from the group consisting of borage oil, canola oil, corn oil, evening primrose oil, flax oil, safflower oil, soybean oil, sunflower oil and combinations thereof.

18. The composition of claim 1, wherein the edible long chain polyunsaturated oil is derived naturally.

19. The composition of claim 1, wherein the edible long chain polyunsaturated oil is derived through chemical modification.

20. The composition of claim 1, wherein the edible long chain polyunsaturated oil comprises a long chain polyunsaturated fatty acid selected from the group consisting of Omega-3 long chain polyunsaturated fatty acid. Omega-6 long chain polyunsaturated fatty acid, and combinations thereof.

21. The composition of claim 1, wherein the edible long chain polyunsaturated oil comprises a long chain polyunsaturated fatty acid selected from the group consisting of arachidonic acid, alpha linolenic acid, docosahexaenoic acid, eicosapentaenoic acid, gamma linolenic acid, linoleic acid and combinations thereof.

22. The composition of claim 1, wherein the edible long chain polyunsaturated oil comprises at least 10% by weight long chain polyunsaturated fatty acids.

23. The composition of claim 1, wherein the edible long chain polyunsaturated oil comprises at least 10% by weight blends of long chain polyunsaturated fatty acids.

24. The composition of claim 1, wherein the edible long chain polyunsaturated oil comprises at least 30% by weight long chain polyunsaturated fatty acids.

25. The composition of claim 1, wherein the edible long chain polyunsaturated oil comprises at least 30% by weight blends of long chain polyunsaturated fatty acids.

26. The composition of claim 1, wherein the edible long chain polyunsaturated oil comprises at least 50% by long chain polyunsaturated fatty acids.

27. The composition of claim 1, wherein the edible long chain polyunsaturated oil comprises at least 50% by weight blends of long chain polyunsaturated fatty acids.

28. The composition of claim 1, wherein the edible long chain polyunsaturated oil comprises at least 70% by weight long chain polyunsaturated fatty acids.

29. The composition of claim 1, wherein the edible long chain polyunsaturated oil comprises at least 70% by weight blends of long chain polyunsaturated fatty acids.

30. The composition of claim 1, wherein the edible long chain polyunsaturated oil comprises at least 90% by weight long chain polyunsaturated fatty acids.

31. The composition of claim 1, wherein the edible long chain polyunsaturated oil comprises at least 90% by weight blends of long chain polyunsaturated fatty acids.

32. The composition of claim 2, wherein the blend of edible oils is selected from the group consisting of animal, plant, algae, microbial, and genetically modified tissues, and combinations thereof.

33. The composition of claim 2, wherein the blend of edible oils is derived from a plant source selected from the group consisting of almond oil, borage oil, black currant seed oil, chia seed oil, camelina oil, canola oil, echium oil, evening primrose oil, flaxseed oil, hemp seed oil, sacha inchi oil, high gamma linolenic acid safflower oil, pumpkin seed oil, perilla oil, peanut oil, safflower oil, soybean oil, sunflower oil, walnut oil, and combinations thereof.

34. The composition of claim 2, wherein the blend of edible oils is derived from an animal source selected from the group consisting of anchovies, catfish, cod, flounder, grouper, halibut, herring, mackerel, pollock, swordfish, salmon, sardines, seal oil, snapper, tuna and combinations thereof.

35. The composition of claim 2, wherein the blend of edible oils is derived from an algae source selected from the group consisting of docosahaexanoic acid rich oil, eicosapentaenoic acid rich oil and combinations thereof.

36. The composition of claim 2, wherein the blend of edible oils is derived from a microbial source selected from the group consisting of alpha linolenic acid rich oil, docosahexaenoic acid rich oil, eicosapentaenoic acid rich oil, gamma linolenic acid rich oil, linoleic acid rich oil and combinations thereof.

37. The composition of claim 2, wherein the blend of edible oils is derived from a genetically modified organism source selected from the group consisting of borage oil, canola oil, corn oil, evening primrose oil, flax oil, safflower oil, soybean oil, sunflower oil and combinations thereof.

38. The composition of claim 2, wherein the blend of edible oils is derived naturally.

39. The composition of claim 2, wherein the blend of edible oils is derived through chemical modification.

40. The composition of claim 2, wherein the blend of edible oils comprises a long chain polyunsaturated fatty acid selected from the group consisting of Omega-3 long chain polyunsaturated fatty acid, Omega-6 long chain polyunsaturated fatty acid, and combinations thereof.

41. The composition of claim 2, wherein the blend of edible oils comprises a long chain polyunsaturated fatty acid selected from the group consisting of arachidonic acid, alpha linolenic acid, docosahexaenoic acid, eicosapentaenoic acid, gamma linolenic acid, linoleic acid and combinations thereof.

42. The composition of claim 2, wherein the blend of edible oils comprises at least 10% by weight long chain polyunsaturated fatty acids.

43. The composition of claim 2, wherein the blend of edible oils comprises at least 10% by weight blends of long chain polyunsaturated fatty acids.

44. The composition of claim 2, wherein the blend of edible oils comprises at least 30% by weight long chain polyunsaturated fatty acids.

45. The composition of claim 2, wherein the blend of edible oils comprises at least 30% by weight blends of long chain polyunsaturated fatty acids.

46. The composition of claim 2, wherein the blend of edible oils comprises at least 50% by long chain polyunsaturated fatty acids.

47. The composition of claim 2, wherein the blend of edible oils comprises at least 50% by weight blends of long chain polyunsaturated fatty acids.

48. The composition of claim 2, wherein the blend of edible oils comprises at least 70% by weight long chain polyunsaturated fatty acids.

49. The composition of claim 2, wherein the blend of edible oils comprises at least 70% by weight blends of long chain polyunsaturated fatty acids.

50. The composition of claim 2, wherein the blend of edible oils comprises at least 90% by weight long chain polyunsaturated fatty acids.

51. The composition of claim 2, wherein the blend of edible oils comprises at least 90% by weight blends of long chain polyunsaturated fatty acids.

52. The composition of claim 1 or 2, wherein the pro-oxidant comprises an antioxidant selected from the group consisting of ascorbic acid, ascorbic acid salts, carotenoids, citric acid, flavonoids, lutein, rosemary extract, sage, sterols, tocopherols, tocotrienols and combinations thereof.

53. The composition of claim 1 or 2, wherein the pro-oxidant is naturally-occurring.

54. The composition of claim 1 or 2, wherein the pro-oxidant is added to the edible long chain polyunsaturated fatty acid oil.

55. The composition of claim 1 or 2, wherein the pro-oxidant is derived from a natural source.

56. The composition of claim 1 or 2, wherein the pro-oxidant is derived from a synthetic source.

57. The composition of claim 1 or 2, wherein the pro-oxidant comprises between about 200 ppm and about 5,000 ppm by weight of pro-oxidant substance.

58. The composition of claim 1 or 2, wherein the pro-oxidant comprises between about 700 ppm and about 3,000 ppm by weight of pro-oxidant substance.

59. The composition of claim 1 or 2, wherein the pro-oxidant comprises between about 1,000 ppm and about 2,000 ppm by weight of pro-oxidant substance.
